(19) United States
(12) Patent Application Publication
(10) Pub. No.: US 2003/0130007 A1
(43) Pub. Date: Jul. 10, 2003

(54) Non-straight wireless mobile device with keys over display

(76) Inventor: G. Eric Engstrom, Kirkland, WA (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/346,331

(22) Filed: Jan. 16, 2003

Related U.S. Application Data
(63) Continuation-in-part of application No. 09/767,526, filed on Jan. 22, 2001.
(63) Continuation-in-part of application No. 09/932,154, filed on Aug. 17, 2001.
(60) Provisional application No. 60/292,123, filed on May 17, 2001.

(51) Int. Cl. H04B 1/38; H04M 1/00

(52) U.S. Cl. 455/550; 455/90

(57) ABSTRACT

A wireless mobile phone comprising a body casing having a top portion and a bottom portion is disclosed. The top portion has a first centerline substantially parallel to two sides of said top portion of the body. The first centerline reflects a positive acute angle with respect to a horizontal reference axis. The bottom portion has a second centerline substantially parallel to two sides of said bottom portion. The bottom portion has a negative acute angle with respect to said horizontal reference axis. An input keypad is disposed on the top portion, the input keypad has a plurality of column of keys that are aligned in a substantially linear manner in parallel to said first centerline. A display screen is disposed on the bottom portion where the display screen has a plurality of columns of pixels that are aligned in a substantially linear manner in parallel to the second centerline.

### RELATED APPLICATIONS

This patent application is a continuation-in-part of non-provisional application Ser. No. 09/767,526 filed Jan. 22, 2001 and titled “A Wireless Mobile Phone With Inverted Placement Of Antenna And Input Keypad” and non-provisional application Ser. No. 09/932,154, filed Aug. 17, 2001, titled “Mobile Electronic Device And Covering For Similar Devices With Ornament Attachment Mechanism”, which claims priority to its provisional filing No. 60/292,123 filed on May 17, 2001.

### BACKGROUND OF THE INVENTION

1. Field of the Invention

The present invention relates to the field of wireless mobile phones. More specifically, the present invention relates to the configuration of the casing of the mobile phone as well as the input keys and the display.

2. Background Information

Advances in computer and telecommunication technology have led to wide spread adoption of mobile client devices, in particular, wireless mobile phones. The term “wireless mobile phone” as used in herein (in the specification and in the claims) refers to the class of telephone devices equipped to enable a user to make and receive calls wirelessly, notwithstanding the user's movement, as long as the user is within the communication reach of a service or base station of a wireless service provider. The term “wireless mobile phone” is to include the analog subclass as well as the digital subclass (of all signaling protocols).

FIG. 1 illustrates a typical prior art wireless mobile phone. As illustrated, prior art wireless mobile phone 100 typically includes input keypad 102, “talk” and “end talk” buttons 104, cursor control buttons 106, display screen 108, antenna 110, ear speaker 112 and microphone 114, disposed relative to each other as shown. Wireless mobile phone 100 also includes palm-sized body casing 116 with top end 118a and bottom end 118b. Input keypad 102, disposed near bottom end 118b, facilitates a user in providing numeric or alphanumeric inputs, whereas “talk” and “end talk” buttons 104, disposed in the mid-section of phone 100, are used to start and end a call. Display screen 108, disposed near top end 118a, is used to echo numeric or alphanumeric inputs entered by a user, as well as to display various menu options, control information, and so forth. Cursor control buttons 106, disposed in the mid-section of phone 100, are used to facilitate a user in making various menu and/or option selections. Microphone 114, also disposed near bottom end 118b, is used to facilitate the user in providing audio input, whereas ear speaker 112, disposed near top end 118a, is used to facilitate outputting for the user, received audio. Antenna 110, disposed at and extruded from top end 118a, is used to send and receive signals, including audio as well as control signals (in a modulated or digitized manner).

Thus, by virtue of the configuration, with ear speaker 112 and antenna 110 disposed at top end 118a, and microphone 114 disposed at bottom end 118b, antenna 110 is inevitably close to the lower right/left brain of a user during operation, giving rise to user concerns with insubstantial amount of electromagnetic radiation to the lower right/left brain. On another issue of lesser controversy, but nevertheless of substantial interest is the fact that, by virtue of the configuration, it is not very convenient to manipulate the input keys of input keypad 102 with the user's thumb. To do so, phone 100 has to be held in a manner with only lower portion 124b resting on the user's palm, and the remaining upper portion 124a overhanging the user's palm unsupported (assuming that the length dimension of phone 100 is in the range of the size of an average human hand, also known as palm-sized).

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates a typical prior art wireless mobile phone;

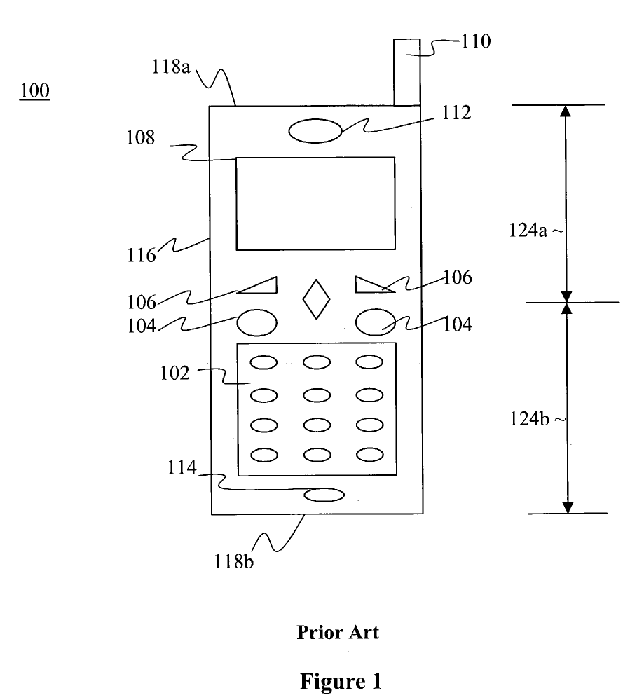

FIG. 2 illustrates a wireless mobile phone, incorporated with the downward extruded antenna and the thumb friendly keypad of the present invention, in accordance with one embodiment;

FIG. 3 illustrates a palm sized, wireless mobile phone, in accordance with one embodiment.

FIG. 4 illustrates a curved, palm sized, wireless mobile phone, in accordance with another embodiment

FIG. 5 illustrates a non-straight wireless mobile device with offset top portion and bottom portion, with reference to a horizontal axis.

FIG. 6 illustrates a curved body mobile device including an internally disposed transceiver and antenna in bottom portion, in accordance with one embodiment.

FIG. 7 illustrates an internal component view of the wireless mobile phone of the present invention, in accordance with one embodiment.

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well known features are omitted or simplified in order not to obscure the present invention. The phrase “in one embodiment” will be used repeatedly, however the phrase does not necessarily refer to the same embodiment, although it may.

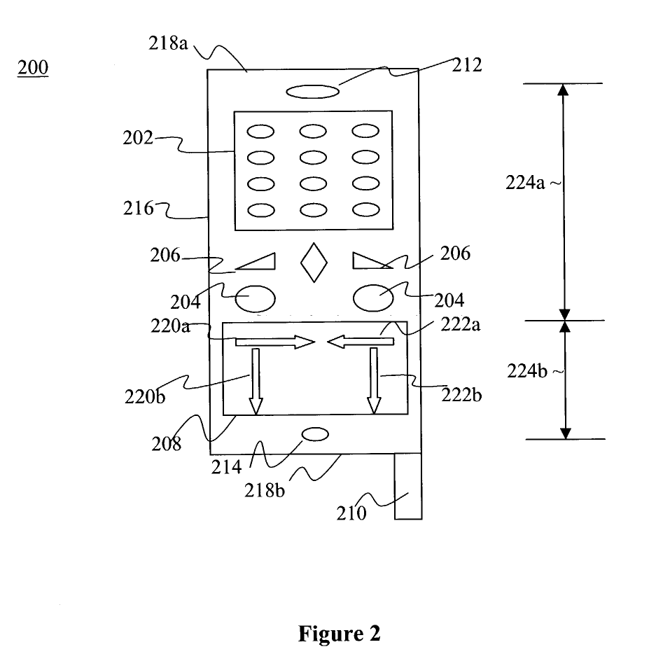

Referring now to FIG. 2, wherein a front view of a wireless mobile phone 200, incorporated with the teachings of the present invention, in accordance with one embodiment, is shown. As illustrated, similar to the earlier described typical conventional wireless mobile phone, wireless mobile phone 200 of the present invention includes input keypad 202 having a number of input keys, “talk” and “end talk” buttons 204, cursor control buttons 206, display screen 208, antenna 210, ear speaker 212 and microphone 214. Wireless mobile phone 200 also includes palmsized body casing 216 with top end 218a and bottom end 218b. Each of these elements is used to provide the same functionality as the functionality provided by the corresponding element of prior art phone 100 described earlier, that is, for the input of numeric or alphanumeric data, for starting and ending a call, and so forth. However, unlike prior art phone 100, antenna 210 and a corresponding transceiver (not shown) are advantageously relocated to be disposed near bottom end 218b, while ear speaker 212 remains disposed at top end 218a. Antenna 210 is designed to extend outward in the downward direction away from bottom end 218b. As a result, during operation, by virtue of the configuration, with ear speaker 212 disposed at upper end 218a and antenna 210 disposed and extruded from bottom end 218b, antenna 210 is likely to be located away from a user's chin. More importantly, antenna 210 is likely to be located much further away from a user's brain, when compared to prior art mobile phone 100, thereby possibly reducing a user's concern with the risk of electromagnetic radiation exposure to the user's brain.

Note that top end 218a and bottom end 218b are objectively determined. A device such as wireless mobile phone 200 having display 208 necessarily has a display orientation. For example, textual data are either rendered from left to right and top to bottom, as denoted by arrows 220a and 220b, as in the case of the English language, or right to left and top to bottom, as denoted by arrows 222a and 222b, as in the case of the Hebrew language, or top to bottom and right to left, as denoted by arrows 222b and 222a, as in the case of the Chinese language. Thus the manner in which textual data are rendered definitively defines which end is the top end, and which end is the bottom end of wireless mobile phone 200. Accordingly, an element A of phone 200 is necessarily above element B of phone 200, and element B is necessarily beneath element A, if element A is closer to the objectively determinable top end of phone 200 (or element B is closer to the objectively determinable bottom end of phone 200).

In addition to the above described advantageous relocation of the antenna 210 to bottom end 218b, for the illustrated embodiment, the disposition of input keypad 202 and display 208 of wireless mobile phone 200 are also advantageously transposed. That is, unlike prior art phone 100, input keypad 202 is advantageously disposed near upper end 218a, while display 208 is disposed near lower end 218b, beneath input keypad 202. The configuration advantageously provides improved accessibility for a user's thumb to manipulate the input keys of input keypad 202. Assuming again phone 200 has a length dimension in the range of the size of an average human hand (i.e. palm-sized), the configuration allows more of phone 200, approximately ⅔ of the body length of phone 200, section 224a, to be resting on the palm of the user, and only about ⅓ of the body length of phone 200, section 224b, overhanging the palm of the user, thereby allowing input keypad 202 to be manipulated by the user's thumb in a more steady manner.

Thus, it can be seen from the above description, wireless mobile phone 200 of the present invention may reduce users concerns with electromagnetic radiation exposure to their brains, and provides improved thumb manipulability for the input keypad.

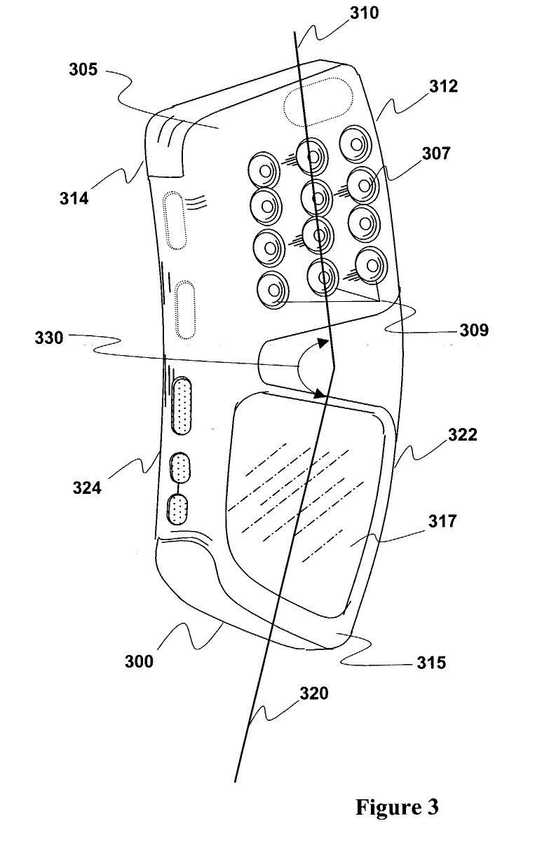

FIG. 3 illustrates a palm sized, wireless mobile phone, in accordance with one embodiment. In the embodiment, the wireless mobile phone contains a curved body 300. The top portion 305 of the wireless mobile phone casing 300 contains a number of keys 307 forming a keypad device. In the embodiment shown, top portion 305 contains three substantially parallel columns 309 of keys. These columns of keys are substantially parallel to sides 312 314 of the top portion 305. The top portion 305 thus, has a centerline 310 formed substantially parallel to the side 312 314 of the top portion 305 of the wireless mobile phone casing 300.

The bottom portion 315 of the wireless mobile phone casing 300 contains a display device 317. Bottom portion 315 also has a centerline 320. This bottom centerline 320 is defined as substantively parallel to sides 322 324 of the bottom portion 315 of the wireless mobile phone casing 300.

The top centerline 310 and bottom centerline 320 meet to form an obtuse angle 330. In this embodiment, this obtuse centerline relationship is used to define the curvature of a wireless mobile phone, and in turn, the relative disposition of the keypad formed with keys 307, and display device 317, to improve ease of use of the wireless mobile phone.

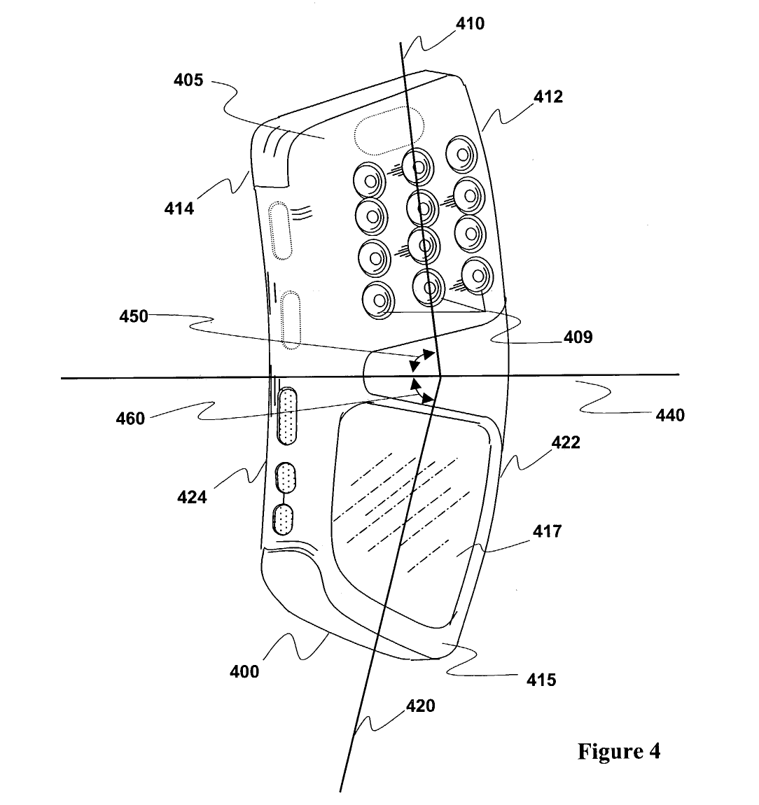

FIG. 4 also illustrates a curved, palm sized, wireless mobile phone 400, in accordance with one embodiment. In this embodiment, curvature of a top portion 405 and a bottom portion 415 are defined with respect to a horizontal axis 440. Top portion 405 contains three substantively parallel columns of keys 409. These columns of keys are substantially parallel to sides 412 414 of the top portion 405. A centerline 410 is defined as parallel to the side 412-414. This top centerline 410 forms an obtuse angle 450 with respect to the horizontal axis 440.

The bottom portion 415 of the wireless mobile phone casing 400 contains a display device 417. Bottom portion 415 also has a centerline 420. The display device 417 contains columns of pixels that are aligned in a substantially linear manner in parallel to the bottom centerline 420. This bottom centerline 420 is defined as substantively parallel to sides 422 424 of the bottom portion 415 of the wireless mobile phone casing 400. This bottom centerline 420 forms a negative obtuse angle 460 with respect to the horizontal axis 440. These obtuse angles 450 460 of the top 405 and bottom 415 portion define the curvature of wireless mobile phone casing 400.

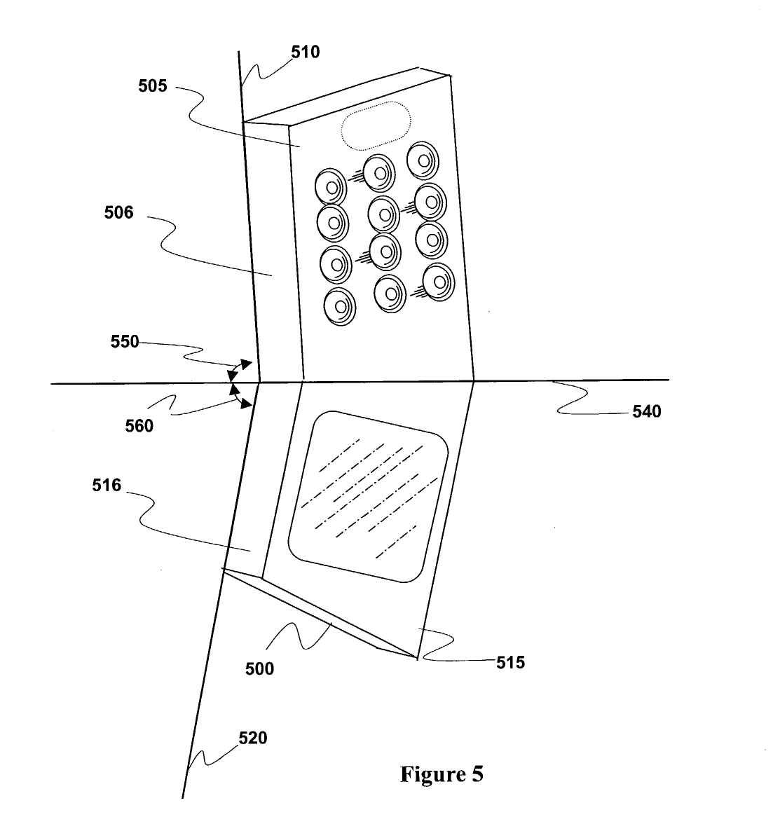

FIG. 5 illustrates a non-straight wireless mobile device with offset top portion 505 and bottom portion 515 with reference to horizontal axis 540. Top portion 505 of wireless mobile device 500 contains two parallel sides. One side 506 is used to define a top reference line 510. This top reference line 510 forms a first angle 550 with respect to horizontal axis 540. Similarly bottom portion 515 of wireless mobile device 500 contains two parallel sides, one of which 516 is used to define a bottom reference line 520 parallel to one side. Bottom reference line 520 forms a second angle 560 with respect to a horizontal axis 540.

Similar to the embodiment of FIG. 4, the two reference lines 510 and 520 form an obtuse angle with respect to a horizontal axis 540 thus providing an angled casing. Further, reference lines 510 and 520, in turn, are employed to define the relative disposition of the keypad disposed on the top portion 505, and the display 515, to improve ease of use of the wireless mobile device.

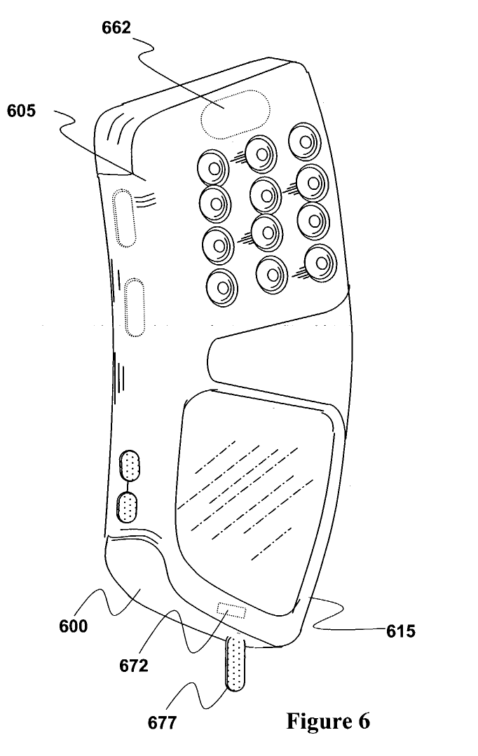

FIG. 6 illustrates a curved body mobile device 600 including an internally disposed transceiver and antenna 677 in bottom portion 615, in accordance with one embodiment. Bottom portion 615 contains a transceiver (not shown) with an antenna 677 that protrudes downward from the bottom portion 615 of the mobile device. In addition, a microphone 672 is disposed in bottom portion 615 of mobile device 600. In contrast, speaker 662 is disposed in top portion 605 of mobile device 600.

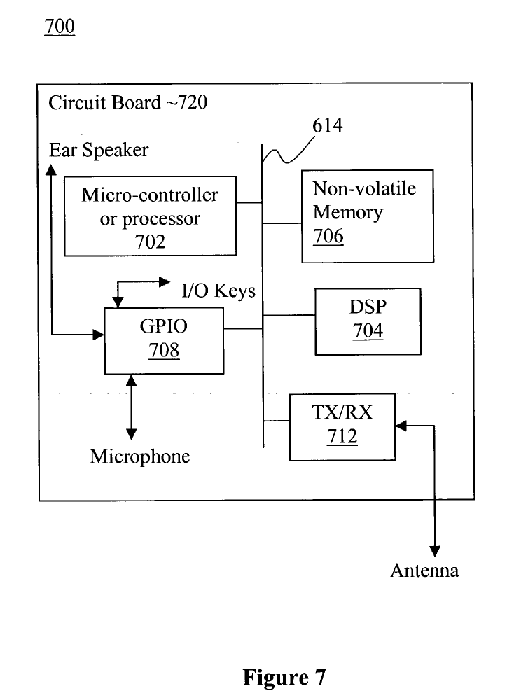

FIG. 7 illustrates an architecture view of a wireless mobile phone 700, in accordance with one embodiment. As illustrated, wireless mobile phone 700 includes elements found in conventional mobile client devices, such as microcontroller/processor 702, digital signal processor (DSP) 704, non-volatile memory 706, general purpose input/output (GPIO) interface 708, and transmit/receive (TX/RX) 712 (also known as a transceiver), coupled to each other via bus 714, and disposed on a circuit board 720. Except for the placement to support the earlier described relative disposition of the ear speaker and the antenna, and the relative disposition of the input keypad and the display, each of these elements performs its conventional function known in the art, and is intended to represent a broad range of such element. In particular, TX/RX 712 may support one or more of any of the known signaling protocols, including but are not limited to CDMA, TDMA, GSM, and so forth. Accordingly, the elements will not be further described.

Thus, a wireless mobile phone having novel non-linear body including relative disposition of the ear speaker and the antenna to reduce a user's concern with the risk of electromagnetic radiation exposure to the user's brain, and a novel relatively disposition of the input keypad and the display to improve thumb manipulability of the keypad has been described. While the present invention has been described in terms of the above illustrated embodiments, in particular, in term of wireless mobile phones, those skilled in the art will recognize that the invention is not limited to the embodiments described. The present invention can be practiced with modification and alteration within the spirit and scope of the appended claims, or on other wireless communication devices. Thus, the description is to be regarded as illustrative instead of restrictive on the present invention.

What is claimed is:

1. A wireless mobile phone comprising:
a curved body casing having a top portion and a bottom portion, said top portion having a first centerline substantially parallel to two sides of said top portion, said first centerline having a positive acute angle with respect to a horizontal reference axis and said bottom portion having a second centerline substantially parallel to two sides of said bottom portion, said bottom portion having a negative acute angle with respect to said horizontal reference axis;
an input keypad disposed on said top portion, the input keypad having a plurality of column of keys that are aligned in a substantially linear manner in parallel to said first centerline; and
a display screen disposed on said bottom portion, the display screen having a plurality of columns of pixels that are aligned in a substantially linear manner in parallel to said second centerline.

2. The wireless mobile phone of claim 1 further comprising an ear speaker internally disposed in said top portion.

3. The wireless mobile phone of claim 1 further comprising an antenna proximately disposed in said bottom portion.

4. The wireless mobile phone of claim 1 further comprising a transceiver internally disposed in said bottom portion.

5. The wireless mobile phone of claim 1 wherein the curved body casing has palm sized dimensions.

6. The wireless mobile phone of claim 1 wherein the wireless mobile phone is a digital type.

7. A wireless mobile phone comprising:
a body casing having a top portion and a bottom portion, said top portion having a first centerline substantially parallel to two sides of said top portion and said bottom portion having a second centerline substantially parallel to two sides of said bottom portion, said first centerline and said second centerline forming an obtuse angle;
an input keypad disposed on said top portion, the input keypads having a plurality of column of keys that are aligned in a substantially linear manner in parallel to said first centerline; and
a display screen disposed on said bottom portion, the display screen having a plurality of columns of pixels that are aligned in a substantially linear manner in parallel to said second centerline.

8. The wireless mobile phone of claim 7 further comprising an ear speaker internally disposed in said top portion.

9. The wireless mobile phone of claim 7 further comprising an antenna proximately disposed in said bottom portion.

10. The wireless mobile phone of claim 7 further comprising a transceiver internally disposed in said bottom portion.

11. The wireless mobile phone of claim 7 wherein the body casing has palm sized dimensions.

12. The wireless mobile phone of claim 7 wherein the wireless mobile phone is a digital type.

13. The wireless mobile phone of claim 7 wherein said body casing is curved.

14. A wireless mobile phone comprising:
a body casing having a top portion and a bottom portion, said top portion having two substantially parallel sides and said bottom also having two substantially parallel sides, the two substantially parallel top sides forming an obtuse angle to the two substantially parallel bottom sides;
an input keypad disposed on said top portion, the input keypads having a plurality of column of keys that are aligned in a substantially linear manner in parallel to said substantially parallel sides of the top portion; and
a display screen disposed on said bottom portion, the display screen having a plurality of columns of pixels that are aligned in a substantially linear manner in parallel to said substantially parallel sides of the bottom portion.

15. The wireless mobile phone of claim 14 further comprising an ear speaker internally disposed in said top portion.

16. The wireless mobile phone of claim 14 further comprising an antenna proximately disposed in said bottom portion.

17. The wireless mobile phone of claim 14 further comprising a transceiver internally disposed in said bottom portion.

18. The wireless mobile phone of claim 14 wherein the body casing has palm sized dimensions.

19. The wireless mobile phone of claim 14 wherein the wireless mobile phone is a digital type.

20. The wireless mobile phone of claim 14 wherein said body casing is curved.
